(19) United States
(12) Patent Application Publication
(10) Pub. No.: US 2025/0236708 A1
(43) Pub. Date: Jul. 24, 2025

(54) Core-Shell Ion-Exchange Resin Formed by Vibrational Nozzle Technique

(71) Applicant: Saudi Arabian Oil Company, Dhahran (SA)

(72) Inventors: Madina Baltaeva, Moscow (RU); Iaroslav Rybkin, Moscow (RU); Anton Manakhov, Moscow (RU); Maxim Orlov, Moscow (RU); Subhash Ayirala, Dhahran (SA)

(21) Appl. No.: 18/421,165

(22) Filed: Jan. 24, 2024

(51) Int. Cl. C08J 3/12; B01J 39/19; B01J 39/20; B01J 41/13; B01J 41/14; C08J 11/08

(52) U.S. Cl. CPC C08J 3/126; B01J 39/19; B01J 39/20; B01J 41/13; B01J 41/14; C08J 11/08

(57) ABSTRACT

A method of making a core-shell ion-exchange resin that includes: dissolving a first polymer waste to form a core polymer solution; dissolving a second polymer waste to form a shell polymer solution immiscible with the core polymer solution; feeding the core polymer solution into an internal nozzle inside an external nozzle; feeding the shell polymer solution into the external nozzle, to a gap between the internal nozzle and the external nozzle; ejecting the core polymer solution from the internal nozzle, forming a laminar flow including the two polymer solutions; vibrating the external nozzle; ejecting the laminar flow from the external nozzle, the vibrating breaking the laminar flow and forming a droplet having a core including the core polymer solution and a shell including the shell polymer solution; and forming, from the droplet, a core-shell ion-exchange resin with a shell including functional groups capable of ion exchange in a solution.

### TECHNICAL FIELD

This disclosure relates to core-shell ion-exchange resin formed by vibrational nozzle technique.

### BACKGROUND

Produced water, which is a highly saline stream, is a byproduct of the production of crude oil and natural gas. Produced water contains dissolved gases such as hydrogen sulfide (H₂S) and carbon dioxide (CO₂), suspended solids, hydrocarbons, heavy metals, emulsified and non-soluble organics, and inorganic salts. Produced water is considered by far the largest volume waste stream in oil and gas industries. Therefore, treating and reusing the produced water is highly desirable from both environmental and operational standpoints.

Water can be cleaned of dissolved salts using a variety of methods, including electrodialysis with ion-exchangeable membranes, reverse osmosis with membranes, nanofiltration, microbial desalination cell technology, and ion exchange demineralization. The use of ion-exchange resins in saline water demineralization can be applied for produced water treatment.

### SUMMARY

This disclosure describes technologies relating to core-shell ion-exchange resin formed by vibrational nozzle technique and methods of the using core-shell ion-exchange resin for produced water treatment.

### BRIEF DESCRIPTION OF DRAWINGS

FIG. 1 is a schematic of a core-shell ion-exchange resin.

FIG. 2 is a schematic of an encapsulation apparatus capable of nozzle vibration.

FIG. 3 is a schematic of a vibrational nozzle unit.

FIG. 4 is a schematic of a filter charged with two core-shell ion-exchange resins.

FIGS. 5A-5B are process flow diagrams of methods of preparing a core-shell ion-exchange resin by vibrational nozzle technique and preparing a filter including the core-shell ion-exchange resin, respectively.

### DETAILED DESCRIPTION

Implementations described herein provide core-shell ion-exchange resin formed by vibrational nozzle technique and methods of making and using the core-shell ion-exchange resin for produced water treatment. The ion-exchange resins have a core-shell structure, where a core polymer is covered by a shell polymer with ion-exchange capability. The core-shell structure can be formed by an encapsulation technique using a vibrational nozzle. The use of the vibrational nozzle allows better control of resin particle size distribution and the shell thickness, thus improving the uniformity of resin bead structure. These improvements can lead to various advantageous characteristics of the resin, including better mechanical strength, resistance to osmotic shock, low pressure drop, easy retrofit, improved diffusion kinetics, and higher operating capacity at any regeneration level. Further, the core-shell ion-exchange resin can be made from recycled, used polymer waste instead of fresh, virgin polymer materials.

In addition to the nozzle vibration, the method of forming the core-shell ion-exchange resin can further include post-encapsulation treatment for surface functionalization such as plasma or chemical treatment to provide functional groups capable of ion-exchange to the shell. The method can also include adding a gas inducing agent in the precursor solutions to improve the porosity of the core-shell ion-exchange resin for better diffusion kinetics. The method can be applied in various polymer materials to prepare different types of ion-exchange resin, e.g., strong or weak acid cation exchange, strong or weak base anion exchange, or chelating.

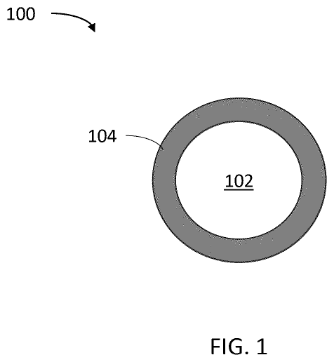

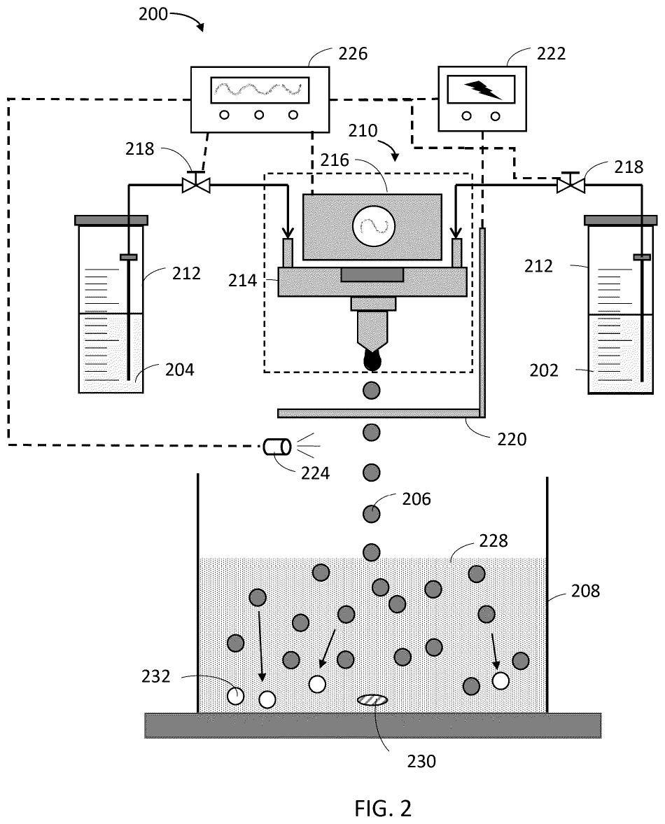

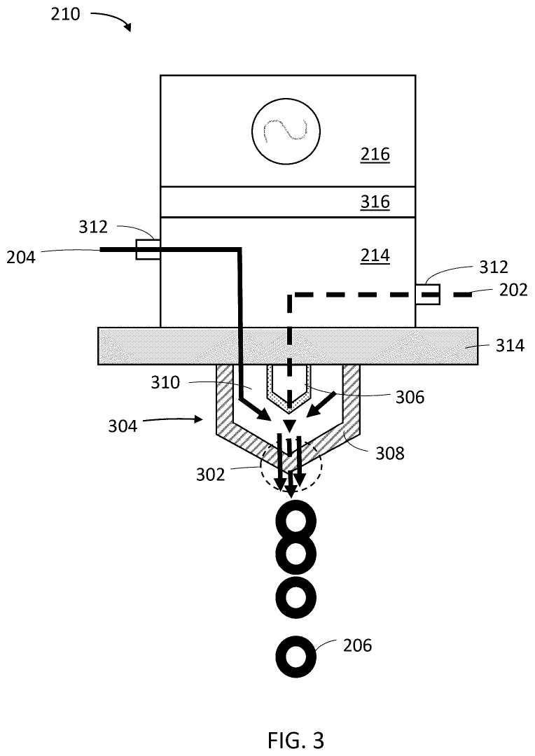

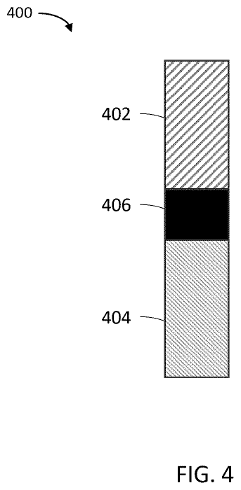

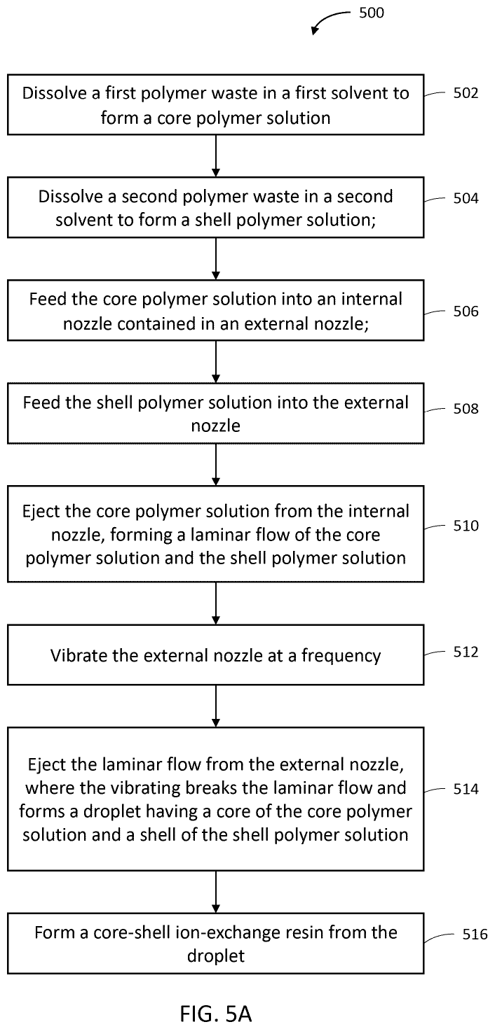

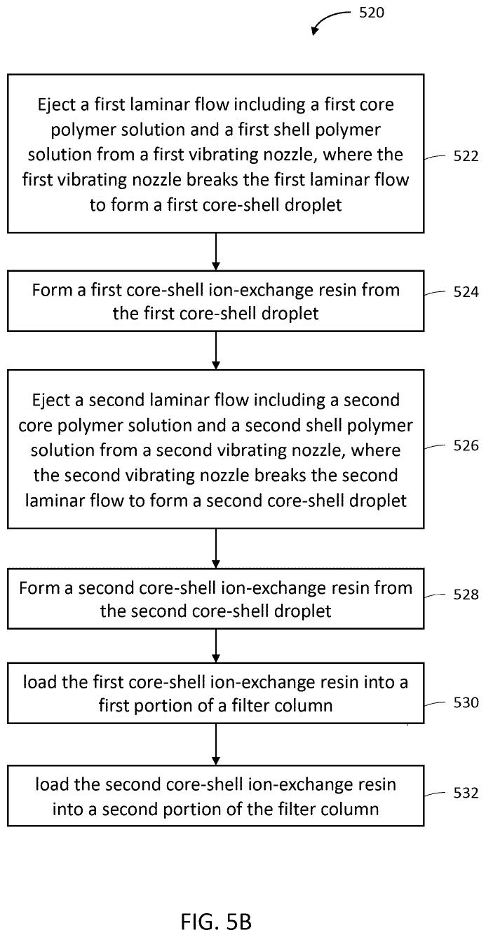

In the following, the preparation of a core-shell ion-exchange resin is described referring to FIG. 1. An example encapsulation apparatus capable of nozzle vibration to prepare the core-shell ion-exchange resin is then described referring to FIGS. 2-3. A filter including the core-shell ion-exchange resin that can be applied in produced water treatment is illustrated in FIG. 4. FIGS. 5A-5B are example process flow diagrams for the method of preparing the core-shell ion-exchange resin by vibrational nozzle technique and preparing the filter including the core-shell ion-exchange resin, respectively. Subsequently, the method of treating produced water using the core-shell ion-exchange resin is described.

### Structure of Core-Shell Ion-Exchange Resin

FIG. 1 illustrates a core-shell ion-exchange resin 100. The core-shell ion-exchange resin described below in this disclosure has a polymer core 102 and a polymer shell 104. In this disclosure, a core-shell structure is characterized by a composition in which a central or inner component (referred to as the core) is encapsulated or surrounded by an outer layer (referred to as the shell) of another component, resulting in a layered or concentric arrangement. In this disclosure, the polymer core 102 and the polymer shell 104 can be formed by different materials. In various implementations, the polymer shell 104 has the ion-exchange capability. The core-shell ion-exchange resin 100 in FIG. 1 is an example of a spherical structure with a single core and a single shell, but the structure of the core-shell ion-exchange resin 100 can have a shape different from this structure. For example, it can have multiple shells, where the polymer shell 104 include multiple layers made of more than one material. In some implementations, the core-shell ion-exchange resin 100 can also have multiple cores surrounded by the polymer shell 104.

Although one bead of the core-shell ion-exchange resin 100 is illustrated in FIG. 1, the method of forming the core-shell ion-exchange resin 100 can generally produce multiple beads, which can be then used to fill a filter column to make an ion-exchange filter. In various implementations, a bead of the core-shell ion-exchange resin 100 can have a diameter between 0.25 mm and 1 mm. The bead can also be characterized by porosity and a large surface area, e.g., 10-50 m²/g or greater, which are beneficial in ion exchange.

In various implementations, the beads of the core-shell ion-exchange resin 100 can have a uniform particle size distribution with 90 to 95% of the beads within +50 μm of the mean diameter and can be made with a mean diameter in the range 300 to 500 μm. In some implementations, the beads can have a relatively small impervious cores with a shell/radius (S/R) ratio of 0.4 or greater. A relatively thin layer for the polymer shell 104 with such a S/R ratio can benefit the diffusion of ions into the polymer shell 104 and thereby the ion-exchange performance. Further, in some implementations, the core-shell ion-exchange resin 100 can have a non-spherical shape, or the encapsulation of the polymer core 102 by the polymer shell 104 may be imperfect.

### Chemical Composition of Core-Shell Ion-Exchange Resin

In various implementations, the polymer core 102 can be made from a thermoplastic polymeric waste. Examples of polymeric waste for the polymer core 102 include polystyrene based copolymer, poly(styrene-isoprene) based copolymer, polyethylene based copolymer, polypropylene based copolymer, aromatic substituted vinyl copolymer, polyether sulfone based copolymer, acrylonitrile butadiene styrene based copolymer, polycarbonate based copolymer, polyhydroxyalkanoate based copolymer, polyhydroxybutyrate based copolymer, polyurethane based copolymer, polyvinyl chloride based copolymer, styrene-acrylate copolymer, polyamide, polyamide based copolymer, polyether, polyether based copolymer, polyimide, polyimide based copolymer, polyolefin, polyolefin based copolymer, polypropylene-polyethylene copolymer, ethylene-vinylacetate copolymer, oxidized polypropylene, oxidized polyethylene, propylene-ethylene oxide copolymer, acrylonitrile-butadiene-styrene copolymer, and any combination thereof. The material with sufficient chemical and mechanical stability to support the structural integrity of the core-shell ion-exchange resin 100 can be selected.

The polymer shell 104 can also be made from a polymeric waste. The polymer shell 104 is capable of ion exchange in a solution. Accordingly, the ion-exchange capability can be inherent to the polymer material of the selected polymeric waste. In some implementations, the ion-exchange capability can be provided or improved by one or more post-encapsulation treatments for surface functionalization. Various types of polymeric waste, e.g., acrylic polymer, amine-containing polymers, polyolefin, and polyester, can be used. The ion exchange can be via cation exchange or anion exchange, and the chemical composition of the polymer shell 104 and its surface functionality can be tailored according to the type of target ions to be exchanged.

The polymer shell 104 can exhibit the ion-exchange capability due to the presence of surface functional groups available for interaction with ions dissolved in the solution. Examples of the functional groups for cation exchange include sulfonic acid groups (—SO₃H), phosphonic acid groups (—PO₃H), phosphinic acid groups (—PO₂H), and carboxylic acid groups (—COOH or —C(CH₃)—COOH).

For inherent cation-exchange capability, examples of polymeric waste for the polymer shell 104 include poly(methyl methacrylate), polymethacrylate, poly(lactic-co-glycolic acid), poly(methyl methacrylate) based copolymer, polymethacrylate based copolymer, poly(lactic-co-glycolic acid) based copolymer, polylactic acid-based copolymer, polyacrylic acid, polyacrylic acid-based copolymer, polyacrylate, polyacrylate based copolymer, and any combination thereof.

The cation-exchange resin can be classified into two groups depending on the acid strength of the functional groups: strong acid cation (SAC) exchange resin and weak acid cation (WAC) exchange resin. The core-shell ion-exchange resin 100 can be prepared to be a SAC or a WAC exchange resin. For example, as a SAC exchange resin, the core-shell ion-exchange resin 100 can include a polystyrene matrix with sulphonate (SO³⁻) functional groups charged with hydrogen ions (H⁺), which can be applied for demineralization. As a WAC exchange resin, the core-shell ion-exchange resin 100 can include, for example, an acrylic polymer hydrolyzed with sulfuric acid or caustic soda to produce carboxylic acid functional groups. Due to their high affinity for H⁺, the WAC exchange resin can be used to remove hardness ions associated with alkalinity, e.g., calcium (Ca²⁺) and magnesium (Mg²⁺). For example, in some implementations, the WAC exchange resin can be used in applications where complete demineralization is not required. The high affinity for divalent cations makes the WAC exchange resin a candidate for applications requiring the removal of hardness ions associated with alkalinity. In some implementations, for the WAC exchange resin, the polymer core 102 include cross-linked polystyrene, and the polymer shell 104 include polyacrylic acid with carboxylic acid functional groups.

Further, the core-shell ion-exchange resin 100 can be prepared as a chelating resin, a special type of cation-exchange resin. The chelating resin can selectively interact with certain heavy metal ions and other substances via chelation. In some implementations, the chelating resin of the core-shell ion-exchange resin 100 can include functional groups such as thiol, triethylammonium, and amino phosphonic groups. The chelating resin can be used in applications where complete demineralization is not required. For example, the chelating resin of the core-shell ion-exchange resin 100 can be used to selectively remove heavy metals from produced water and generate a brine solution that can be further processed to provide drilling or completion fluids.

On the other hand, in some implementations, the core-shell ion-exchange resin 100 can be prepared as an anion-exchange resin. Examples of functional groups for anion exchange include quaternary ammonium groups, tertiary amine functional groups, secondary amine functional groups, and primary amine functional groups. The quaternary ammonium groups are, for example, benzyltrimethylammonium groups, benzyldimethylethanolammonium groups, or trialkylbenzyl ammonium groups.

For inherent anion-exchange capability, examples of polymeric waste for the polymer shell 104 include aliphatic polyamine, mixed polyalkylene amine, resins containing amine or dimethyl amine functional groups, amine derivative resins, and any combination thereof.

The anion-exchange resin can be classified into two groups depending on the base strength of the functional groups: strong base anion (SBA) exchange resin and weak base anion (WBA) exchange resin. The core-shell ion-exchange resin 100 can be prepared to be an SBA or a WBA exchange resin. For example, as an SBA exchange resin, the core-shell ion-exchange resin 100 can include a polystyrene matrix that has undergone chloromethylation and amination to fix anions to exchange sites. As a WBA exchange resin, the core-shell ion-exchange resin 100 can include, for example, a polystyrene matrix that has undergone chloromethylation, followed by amination with dimethylamine. WBA exchange resins are unique in that they do not have exchangeable ions and are therefore used as acid absorbers to remove anions associated with strong mineral acids. Accordingly, the WBA exchange resin of the core-shell ion-exchange resin 100 can be used in applications where complete demineralization is not required. For complete demineralization applications, the WBA exchange resin beds can be paired with the SBA exchange resin. WBA exchange resins are also can be used for acid adsorption applications, including the removal of chloride, sulphate, nitrate, and other anions associated with strong acids.

Further, for implementations with surface functionalization, various polymers such as polyolefin, polyester, and their derivatives can be used for the polymer shell 104. Examples of polymeric waste for the polymer shell 104 include polyolefins polypropylene, polyethylene, polyethylene-based copolymer, polypropylene based copolymer, polyphenylene oxide, polyether sulfone, polyester, polyethylene terephthalate, ethylene-vinylacetate copolymer, oxidized polypropylene, oxidized polyethylene, propylene-ethylene oxide copolymer, and any combination thereof. In these implementations, post surface treatments can be performed to functionalize the surface of the polymer shell 104 to provide the ion-exchange capability.

As described above, various polymer materials can be used for both the polymer core 102 and the polymer shell 104. Compared with highly crosslinked polymers that cannot easily be functionalized, the capability of the method in the disclosure to use more active polymers for the polymer shell 104 can increase the functionalization efficiency and the ion-exchange capability because highly crosslinked polymer does not easily functionalize under normal reaction conditions.

### Preparation of Core-Shell Ion-Exchange Resin

The core-shell ion-exchange resin 100 can be prepared by encapsulating a first polymer component inside a second polymer component. In various implementations, the method of forming the core-shell ion-exchange resin 100 uses a vibrational nozzle technique for encapsulation. The vibrational nozzle technique described below uses a two-flow concentric nozzle and the vibration of the nozzle. The vibration is in resonance with the Rayleigh instability and enables forming core-sell uniform droplets at microscales. The formed core-shell droplets can then be solidified by removing the solvents to form the core-shell resin. In some implementations, subsequent functionalization treatment, e.g., plasma or chemical treatments, can be performed before obtaining the core-shell ion-exchange resin 100.

In various implementations, as starting materials for the core-shell ion-exchange resin 100, one or more polymer waste materials can be collected and pretreated. When the target polymer material is present in a polymer waste mixture, it must be first isolated and purified. For example, the expanded polystyrene (EPS) can be used as the source for polymer core creation. In some implementations, the EPS wastes from packaging for electronic appliances, thermal insulation in construction and in refrigerators can be used. Other examples of sources of thermoplastic polymer wastes such as high density polyethylene (HDPE), low density polyethylene (LDPE), and polypropylene (PP) that can be recycled for polymeric core creation include soap bottles, containers, trash bags, food containers and bags. In case of the shell creation, the disposed baths, TV screens and signage made of polymethyl methacrylate can be used.

In various implementations, the process of waste treatment to recover the starting materials for the core-shell ion-exchange resin 100 begins with the separation, washing, and grinding of plastics. Impurities can be present in high concentrations in post-consumed plastics (e.g., 1 mg/kg or greater). Some of impurities are Volatile Organic Compounds (VOCs) and their compositions and types may depend on the polymer type. They come from additives added during the polymerization, such as phenolic antioxidants, consumed during the stabilization process. Furthermore, residues of titanium and aluminum polymerization generate colored salt. Plastics can absorb contaminants, and the migration of some products to the matrix of packaging influences the quality of the material after being recycled. Decontamination can be performed by a degassing system or/and filtration system.

In various implementations, the method of forming the core-shell ion-exchange resin 100 includes preparing two fluids: one fluid including one polymer component and the other fluid including another polymer component. The two fluids can be provided to an encapsulation apparatus 200 (FIG. 2) that is capable of nozzle vibration.

In some implementations, the preparation of the fluids includes a pretreatment of washing the polymer waste mixture including a first polymer waste, isolating the first polymer waste from the polymer waste mixture, and grinding the first polymer waste into granules. The granules of the isolated first polymer waste can be dissolved in a first solvent to form a core polymer solution 202 (FIG. 2). Here, the first polymer waste can be used to form the polymer core 102. Similarly, a pretreatment can be performed to isolate and obtain a second polymer waste for the polymer shell 104. The second polymer waste can also be ground into granules and dissolved in a second solvent to form a shell polymer solution 204 (FIG. 2). These two solutions can be fed to a two-flow concentric nozzle that can vibrate for encapsulation.

Examples of the solvent to prepare a core or shell polymer solution include alkanes (e.g., n-octane, n-dodecane, cyclohexane, and methylcyclohexane), aromatic hydrocarbons (e.g., benzene, toluene, naphthalene, styrene, o-xylene, ethylbenzene, an diethylbenzene), halohydrocarbons (e.g., dichloromethane, dichloroethane, chloroform, carbon tetrachloride, chlorobenzene, and o-dichlorobenzene), ethers (e.g., tetrahydrofuran, diethyl ether, dibenzyl ether, and 1,4-dioxane), ketones (e.g., acetone, butanone, cyclohexanone, diethyl ketone, acetophenone, methyl isobutyl ketone, methylisoamyl ketone, and isophorone), esters (e.g., methyl acetate, ethyl formate, propylene 1,2 carbonate, ethyl acetate, diethyl carbonate, diethyl sulfate, and n-butyl acetate), nitrogen-containing compounds (e.g., pyridine, morpholine, N,N-dimethylformamide, and acetonitrile), alcohols (e.g., ethanol, isopropanol, propanol, butanol, and benzyl alcohol), and mixtures thereof.

Two different solvents are used for the two solutions. To enable encapsulation from the two solutions, the solvent for the first polymer waste and the solvent for the second polymer waste must be immiscible. This disclosure primarily describes the use of polymer solutions where the polymer wastes are dissolved in the selected solvent systems, which can benefit the scale up of the system. In some implementations, however, the method of forming the core-shell ion-exchange resin 100 can use other types of fluids such as emulsions, suspensions, and polymer melts. For example, in case of using crosslinked polystyrene as the polymer core, benzene can be used as the solvent for the first polymer waste. In some implementations, the polymer shell includes poly(methyl methacrylate) (PMMA) and the solvent for the second polymer waste can include 2-methoxyethanol.

In some implementations, in order to generate pores in the core-shell ion-exchange resin 100, additives can be added to the core polymer solution 202, the shell polymer solution 204, or both. The additives can include, for example, a gas inducing agent and an acid that can trigger the gas formation. In some implementations, the gas formation can occur during the stage of solidification and precipitation, creating permanent pores. Examples of the gas inducing agent include carbonate or bicarbonate such as alkali metal, alkaline earth metal, and ammonium carbonates and bicarbonates. The acid can be organic acids, including, but not limited to, lactic acid, acetic acid, formic acid, citric acid, and oxalic acid, and also mineral acids, including but not limited to hydrochloric acid, hydrofluoric acid, and nitric acid. Carbonate can generate CO₂ during capsules precipitation and form the pores in the resins to create the high surface area.

The two fluids, e.g., the core polymer solution 202 and the shell polymer solution 204, can then be processed by the encapsulation apparatus 200 for encapsulation using vibrational nozzle technique. As further described below referring to the design of the encapsulation apparatus 200 in FIG. 2, the two fluids, being immiscible to each other, can form a laminar flow. This laminar flow can then break into core-shell droplets 206 with uniformity by vibrating the nozzle (FIG. 2). The core-shell droplets 206 are immersed in a bath 208 for solvent removal and precipitation.

### Encapsulation Apparatus Capable of Nozzle Vibration

For encapsulation of the core polymer solution 202, a commercial system (e.g., Inotech encapsulator IE-50R) can be used. FIG. 2 is a schematic of an example apparatus with components for nozzle vibration. Although not specifically illustrated, other reasonable designs of encapsulation apparatus can be used. In FIG. 2, the encapsulation apparatus 200 includes a vibrational nozzle unit 210 connected to two container bottles 212, one containing the core polymer solution 202 and the other containing the shell polymer solution 204. In some implementations, the container bottles 212 can be pressure bottles with pressure control capability for solution delivery. The encapsulation apparatus 200 further includes the bath 208 to receive the core-shell droplets 206. The vibrational nozzle unit 210 includes a pulsation body 214 and a vibration unit 216. The vibration can be created by the vibration unit 216 and transferred to the pulsation body 214. Pressure valves 218 can be disposed between the container bottles 212 and the pulsation body 214.

Further, as illustrated in FIG. 2, the encapsulation apparatus 200 can be capable of applying an electric potential between the vibrational nozzle unit 210 and an electrode 220 using a power source 222. In various implementations, the electrode 220 has a hole such that the core-shell droplets 206 can pass through the electrode 220 without making a physical contact with the electrode 220. The electrode 220 can further have screws of a clip to change the length of the clip. The electrode 220 can be attached from below to a heating block. The distance between the electrode and the nozzle tip can be changed as needed. This distance can be approximately 3 to 8 mm. The distance should be set so that the core-shell droplets 206 are formed near the upper side of the electrode 220. When the core-shell droplets 206 pass through the electrode hole, they pick up the electrostatic charge from the electrode surface. This electrostatic charge can then be transferred to the bath 208 and accumulates if the bath 208 is not grounded. This scenario may not be ideal because the electrostatic field created by the accumulated charges can be so strong that small droplets are repelled over the bath 208 and will no longer sink into a resin precipitation medium 228. Therefore, the bath 208 can be equipped with a grounding hook attached to a grounding wire so that the electrostatic charges can flow to ground to avoid charge buildup. The applied electric potential can induce charges on the surface of the core-shell droplets 206 and thereby repulsion among the core-shell droplets 206, improving their dispersion. In some implementations, a voltage up to about 2.15 kV can be applied. The voltage can be adjusted to control the degree of dispersion and the droplet size of the core-shell droplets 206.

The encapsulation apparatus 200 can also include an optical sensor 224 to monitor the formation of the core-shell droplets 206. The optical sensor 224 can include an optical detector and a lamp, e.g., a light emitting diode (LED) or a stroboscope. In some implementations, using a stroboscopic lamp synchronized to the frequency of the nozzle vibration, it is possible to capture images of individual droplets. Based on the stroboscopic effect, the regular, stable formation of the core-shell droplets 206 can be seen as a series of droplets moving down, completely stopped, or moving up.

A controller 226 of the encapsulation apparatus 200 can be configured to control the vibration frequency of the vibrational nozzle unit 210. In some implementations, the controller 226 can be further connected to various components of the encapsulation apparatus 200 and capable of controlling various process parameters such as the frequency for the stroboscope, the flow rates of the core and shell polymer solutions, and the voltage applied to the electrode 220.

In various implementations, the bath 208 contains the resin precipitation medium 228 and a magnetic stir bar 230. The resin precipitation medium 228 can include deionized water, ethanol, or heptane. Although not wishing to be limited by any theory, in the bath 208, the solvents within the core-shell droplets 206 can gradually diffuse out to the bath, solidifying the droplets and forming the core-shell solid particles 232. The core-shell solid particles 232 can be directly recovered as the core-shell ion-exchange resin 100 or need to be further processed for surface functionalization. Further, during the solvent diffusion, pores can be formed in the core-shell solid particles 232, which can be an important characteristic for applications in ion-exchange resin. In some implementations, the bath temperature can be controlled to improve the solvent diffusion. For example, the bath temperature can be maintained between about 20° C. and about 120° C.

### Vibrational Nozzle Unit

In FIG. 3, the vibrational nozzle unit 210 is further illustrated with its components and the process of forming an immiscible laminar flow 302 followed by breaking into the core-shell droplets 206 is described below. Like numbered items are as described with respect to FIG. 2. The vibrational nozzle unit 210 has a two-flow concentric nozzle system 304, which can include an internal nozzle 306 an external nozzle 308. The internal nozzle 306 is surrounded and contained in the external nozzle 308, and the two nozzles are positioned concentrically with aligned openings. Accordingly, the internal nozzle 306 is configured to eject a first fluid, e.g., the core polymer solution 202, inside the external nozzle 308. There is a gap 310 between the exterior of the internal nozzle 306 and the interior of the external nozzle 308 such that a second fluid, e.g., the shell polymer solution 204, can be provided to the gap 310. Luer connections 312 can be used to deliver the two fluids to the respective nozzles. The concentric configuration of the two nozzles with appropriate solvent selection to be immiscible can allow the flow of the core polymer solution 202 to be surrounded by the flow of the shell polymer solution 204, forming the immiscible laminar flow 302. The immiscible laminar flow 302 can be ejected from the opening of the external nozzle 308. By ejecting the immiscible laminar flow 302 while vibrating the external nozzle 308, the immiscible laminar flow 302 can be broken into a series of the core-shell droplets 206.

In some implementations, the two-flow concentric nozzle system 304 can be mounted on a carrier plate 314, which is connected to the pulsation body 214 and the vibration unit 216. A magnet holder 316 can be positioned between the pulsation body 214 and the vibration unit 216.

The design of the two-flow concentric nozzle system 304 and the process conditions for encapsulation can be selected to optimize metrics such as the droplet size, size distribution, and the thickness of the shell, e.g., S/R ratio in view of the applications in ion-exchange resin. In some implementations, the internal nozzle 306 has an opening with a diameter between about 0.1 mm and about 1 mm. On the other hand, the external nozzle 308 can have an opening with a diameter between about 0.5 mm and about 10 mm. The vibration frequency can be, for example, between 40 Hz and 6 kHz. The ejection rate by gas pressure can be selected from the range between about 0.5 ml/min and about 200 ml/min. In some implementations, the encapsulation apparatus 200 can be operated to flow the two solutions at a pressure up to 1.5 bar (150 kPa). While the vibration frequency may be adjusted simultaneously for both solutions, the ejection rate, temperature, and pressure can be controlled individually for each solution.

### Post-Encapsulation Surface Treatment

As described above referring to FIG. 2, the core-shell solid particles 232 may need to be further processed for surface functionalization to obtain the core-shell ion-exchange resin 100. In some implementations, a plasma treatment or a chemical treatment can be performed to introduce the functional groups capable of ion exchange on the surface of the polymer shell 104.

Reagent for plasma treatment can be a sulfur-containing gas such as SO₂, SO₂/O₂ mixture and SO₂/H₂O mixture for sulfur introduction, a nitrogen-containing gas such as NH₃/C₂H₂ or NH₃/C₂H₄ for introducing primary amine. Examples of amines for the reagent include allylamine (C₃H₅NH₂), ethylenediamine, triethylene glycol dimethyl ether, octadecylamine, 1,2-diaminocyclohexane, tetramethylenediamine, polyethyleneimine, N-methylpyrrolidone, 2-(Dimethylamino)ethyl methacrylate, and N,N-dimethylhexylamine.

The precursors for chemical treatment can be selected from the group of suitable sulfonating agent: sulfuric acid, fuming sulfuric acid (oleum, SO₃), acetyl sulphate, 1,3-propane sulfone, chlorosulfonic acid, sodium sulphate, styrene sulfonic acid. Examples of functional groups for chemical modification by chelation also include iminodiacetic acid, aminodiacetic acid, and aminophosphonic acid.

### Ion-Exchange Filter

FIG. 4 is a schematic of an ion-exchange filter 400 charged with a core-shell ion-exchange resin 100. In various implementations, the ion-exchange filter 400 has two sections: a first filter section 402 and a second filter section 404, separated by a joint or a connector section 406. The first filter section 402 can be for cation exchange and the second filter section 404 can be for anion exchange. In some implementations, at least one of the resins for the two sections can include the core-shell ion-exchange resin 100. Alternately, two different types of core-shell ion-exchange resin 100 can be prepared and both two sections can be charged with the core-shell ion-exchange resins 100, respectively. In some implementations, a chelating resin of the core-shell ion-exchange resin 100 can be used to fill one of the two sections. The joint or connector section 406 is charged with inert materials such as gravel or unreactive plastic beads to prevent the mixing of the first and second filter sections. This separation can benefit the ion-exchange of each of the resins and can also reduce the risk of channeling, where the solution flows only in certain paths unevenly in the sections. In some implementations, the ion-exchange filter 400 can have one mixed bed structure without a joint or a connector section 406, and the mixed bed structure is capable of both cation and anion exchange. Further, the ion-exchange filter 400 can be demountable from a filtration apparatus, which allows efficient regeneration of the resins of the ion-exchange filter 400.

FIGS. 5A-5B are example process flow diagrams of methods of preparing a core-shell ion-exchange resin by vibrational nozzle technique and preparing a filter including the core-shell ion-exchange resin, respectively. In FIG. 5A, a method 500 according to an implementation starts with dissolving 502 a first polymer waste in a first solvent to form a core polymer solution and dissolving 504 a second polymer waste in a second solvent to form a shell polymer solution. Subsequently, the core polymer solution is fed 506 into an internal nozzle contained in an external nozzle, and the shell polymer solution is fed 508 into the external nozzle, to a gap between the exterior of the internal nozzle and the interior of the external nozzle. The core polymer solution is then ejected 510 from the internal nozzle, forming a laminar flow including the core polymer solution and the shell polymer solution. The shell polymer solution is immiscible with the core polymer solution. The external nozzle can then be vibrated 512 at a frequency, and while vibrating the external nozzle, the laminar flow is ejected 514 from the external nozzle, where the vibrating breaks the laminar flow and forms a droplet having a core including the core polymer solution and a shell including the shell polymer solution. A core-shell ion-exchange resin can be formed 516 from the droplet, where the core-shell ion-exchange resin has a shell including functional groups capable of ion exchange in a solution.

In FIG. 5B, a method 520 for preparing a filter including the core-shell ion-exchange resin starts with ejecting 522 a first laminar flow including a first core polymer solution and a first shell polymer solution from a first vibrating nozzle, where the first vibrating nozzle breaks the first laminar flow to form a first core-shell droplet, followed by forming 524 a first core-shell ion-exchange resin from the first core-shell droplet. A second laminar flow including a second core polymer solution and a second shell polymer solution is ejected 526 from a second vibrating nozzle, where the second vibrating nozzle breaks the second laminar flow to form a second core-shell droplet, followed by forming 528 a second core-shell ion-exchange resin from the second core-shell droplet. Subsequently, the method 520 proceeds to loading 530 the first core-shell ion-exchange resin into a first portion of a filter column and loading 532 the second core-shell ion-exchange resin into a second portion of the filter column.

### Produced Water Treatment Using Ion-Exchange Filter

Produced water treatment involves various processes such as oil/water separation, solid removal, desalination, and gas stripping (e.g., H₂S and CO₂). The desalination of produced water can be performed by ion exchange, particularly using the core-shell ion-exchange resin 100 described in this disclosure. Generally, the saline solution, e.g., produced water, can be flowed through a column, e.g., the first filter section 402, with a cation-exchange resin, which can be one of the core-shell ion-exchange resin 100. Cations in the solution, e.g., sodium (Na⁺), magnesium (Mg²⁺), and calcium (Ca²⁺) ions, can be exchanged with hydrogen (H⁺) ions of the cation-exchange resin. Subsequently, the solution can next be flowed through another column or a section of the same column, e.g., the second filter section 404, charged with an anion-exchange resin, which can be another one of the core-shell ion-exchange resin 100. Anions in the solution, e.g., chloride (Cl⁻), sulfate (SO₄²⁻), carbonate (CO₃²), and bicarbonate (HCO₃⁻) ions, can be exchanged with hydroxide ions (OH⁻) ions of the anion-exchange resin. Process conditions for the desalination can depend on total dissolved solids (TDS) in the saline solution. For example, the rate of passage of the produced water through the ion-exchange filter 400 can be from about 2 and 20 bed volumes per hour and can be conducted under ambient conditions such as at about 25° C.

### Examples

For plasma-based surface functionalization, a plasma sulfonation process can be used to produce a strong acidic cation (SAC) exchange resin can be obtained by plasma sulfonation process. For example, polypropylene can be modified by plasma containing SO₂, SO₂/O₂ or SO₂/H₂O. The plasma conditions for obtaining the highest sulfur content are selected from the following range: SO₂ gas flow of from 20 to 60 cm³/min, RF power of from 30 to 250 W, and the treatment time of from 1 to 30 min.

In another example, the polymer shell 104 can also be modified by gas-liquid interfacial plasma and —COOH, —OH, and —SO₃H groups can be anchored under air-argon medium. The time of treatment depends on the type of polymer and can be from 10 min to 2 hours. The maximum concentration of sulfuric acid can be at 1 M to prevent the electrolysis of the species. A high-voltage bipolar pulse generator can be used for power supply.

The weak acidic cation (WAC) exchange resin can be obtained by gas plasma process in the presence of CO₂. Conditions for plasma treatment are selected from the following range: voltage of from 10 to 50 V, 1-2 A, the treatment time of from 2 to 30 min, and the gas flow of from 10 to 70 ml/min.

The strong base anion (SBA) exchange resin can be obtained by the nitrogen plasma-based functionalization of the shell followed by the in situ building of functional structures using polyfunctional amines. After plasma exposure, the core-shell capsules can be immersed in solution of tertiary or quaternary amines in alkali medium for 30 min to 2 hours. For example, benzyltrimethylammonium groups can be grafted on the core-shell capsules surface.

The weak base anion (WBA) exchange resin can be obtained by gas plasma amination process. Primary amine groups can be grafted by NH₃/C₂H₂ or NH₃/C₂H₄ plasma. Allylamine (C₃H₅NH₂) can also be used. The treatment time can be from 1 to 40 min, the allylamine monomer vapor can be introduced at 0.4 mbar pressure, and the electrical discharge can be ignited at 20 W. In one example, cyclopropylamine (CPA) can be used for anion-exchange resin creation in squared pulsed CPA/Ar plasma at 100 W and the pressure of 50 Pa. The pulse duty cycle and repetition frequency are 33% and 500 Hz, respectively. The deposition time is 60 min.

For chemical surface functionalization, the strong acidic cation (SAC) exchange resin can be obtained by chemical sulfonation process. The suitable sulfonating agent can be selected from sulfuric acid, fuming sulfuric acid (oleum, SO₃), acetyl sulphate, 1,3-propane sulfone, chlorosulfonic acid, sodium sulphate, or styrene sulfonic acid.

The weak acidic cation (WAC) exchange resin can be obtained by carboxylation. For example, carboxylated polypropylene can be prepared by grafting maleic anhydride onto available polypropylene in the presence of a free-radical generating catalyst such as a peroxide.

A chelating resin can be obtained by attachment of chelate groups to a weakly basic ion exchange resin. For example, anion-exchange resins with carboxylic groups can be immersed in the solution iminodisuccinic acid sodium salt in water with further pH adjustment. The modified chelate resin can be used for heavy metal removal from produced water.

### Implementations

An implementation described herein provides a method of making a core-shell ion-exchange resin, where the method including: dissolving a first polymer waste in a first solvent to form a core polymer solution; dissolving a second polymer waste in a second solvent to form a shell polymer solution, the second polymer waste being different from the first polymer waste; feeding the core polymer solution into an internal nozzle contained in an external nozzle; feeding the shell polymer solution into the external nozzle, to a gap between the exterior of the internal nozzle and the interior of the external nozzle; ejecting the core polymer solution from the internal nozzle, forming a laminar flow including the core polymer solution and the shell polymer solution, the shell polymer solution being immiscible with the core polymer solution; vibrating the external nozzle at a frequency; while vibrating the external nozzle, ejecting the laminar flow from the external nozzle, the vibrating breaking the laminar flow and forming a droplet having a core including the core polymer solution and a shell including the shell polymer solution; and forming a core-shell ion-exchange resin from the droplet, the core-shell ion-exchange resin having a shell including functional groups capable of ion exchange in a solution.

In an aspect, combinable with any other aspect, the method further includes: prior to dissolving the first polymer waste, washing a polymer waste mixture including the first polymer waste; isolating the first polymer waste from the polymer waste mixture; and grinding the first polymer waste into granules.

In an aspect, combinable with any other aspect, the method further includes: prior to dissolving the second polymer waste, washing a polymer waste mixture including the second polymer waste; isolating the second polymer waste from the polymer waste mixture; and grinding the second polymer waste into granules.

In an aspect, combinable with any other aspect, the method further includes, prior to feeding the core polymer solution into an internal nozzle, adding a carbonate and an acid to the core polymer solution, a gas is formed by a reaction of the carbonate and the acid while forming the core-shell ion-exchange resin, and the gas forms pores in a core of the core-shell ion-exchange resin.

In an aspect, combinable with any other aspect, the method further includes, prior to feeding the shell polymer solution into an external nozzle, adding a carbonate and an acid to the shell polymer solution, a gas is formed by a reaction of the carbonate and the acid while forming the core-shell ion-exchange resin, and the gas forms pores in the shell of the core-shell ion-exchange resin.

In an aspect, combinable with any other aspect, the first polymer waste includes a polystyrene based copolymer, a poly(styrene-isoprene) based copolymer, an aromatic substituted vinyl copolymer, a polyurethane based copolymer, an acrylonitrile butadiene styrene-based copolymer, a polyimide, or a polyimide based copolymer.

In an aspect, combinable with any other aspect, the second polymer waste includes an acrylic polymer, a polyolefin, a polyester, or an amine-containing polymer.

In an aspect, combinable with any other aspect, the internal nozzle has an opening with a diameter between 0.1 mm and 1 mm, and the external nozzle has an opening with a diameter between 0.5 mm and 10 mm.

In an aspect, combinable with any other aspect, the frequency is between 40 Hz and 6 kHz.

In an aspect, combinable with any other aspect, the method further includes providing the droplet into a polymer precipitating bath, precipitating a solid core-shell resin.

In an aspect, the solid core-shell resin has a shell including functional groups capable of ion exchange in a solution.

In an aspect, the solid core-shell resin has a shell without the functional groups, and forming the core-shell ion-exchange resin includes performing a plasma treatment on the solid core-shell resin to form the functional groups on the shell of the solid core-shell resin.

In an aspect, the solid core-shell resin has a shell without the functional groups, and forming the core-shell ion-exchange resin includes performing a chemical treatment on the solid core-shell resin to form the functional groups on the shell of the solid core-shell resin.

In an aspect, combinable with any other aspect, the solid core-shell ion exchange resin is a cation-exchange resin, and the functional groups include sulfonic acid, carboxylic acid, or chelating ligands.

In an aspect, combinable with any other aspect, the solid core-shell ion-exchange resin is an anion-exchange resin, and the functional groups include amines.

An implementation described herein provides a method of making an ion-exchange filtration system, where the method includes: ejecting a first laminar flow including a first core polymer solution and a first shell polymer solution from a first vibrating nozzle, the first vibrating nozzle breaking the first laminar flow to form a first core-shell droplet; forming a first core-shell ion-exchange resin from the first core-shell droplet; ejecting a second laminar flow including a second core polymer solution and a second shell polymer solution from a second vibrating nozzle, the second vibrating nozzle breaking the second laminar flow to form a second core-shell droplet; forming a second core-shell ion-exchange resin from the second core-shell droplet; loading the first core-shell ion-exchange resin into a first portion of a filter column; and loading the second core-shell ion-exchange resin into a second portion of the filter column.

In an aspect, combinable with any other aspect, the first core-shell ion-exchange resin has a shell including a cation-exchange resin and the second core-shell ion-exchange resin has a shell including an anion-exchange resin.

In an aspect, combinable with any other aspect, the first core-shell ion-exchange resin or the second core-shell ion-exchange resin has a shell including a chelate resin.

In an aspect, combinable with any other aspect, the method further includes performing a plasma treatment or a chemical treatment on the first or second core-shell ion-exchange resin to introduce functional groups capable of ion exchange in a solution.

In an aspect, the functional groups include sulfonic acid, carboxylic acid, chelating ligands, or amines.

An implementation described herein provides a system for forming a core-shell ion-exchange resin, where the system includes: a first container including a core polymer solution, the core polymer solution being prepared by dissolving a first polymer waste in a first solvent; a second container including a shell polymer solution, the shell polymer solution being prepared by dissolving a second polymer waste in a second solvent; a vibrational nozzle unit including, a vibration unit configured to vibrate at a frequency, a carrier plate, an internal nozzle mounted on the carrier plate, the internal nozzle configured to receive the core polymer solution and to eject the core polymer solution through a first opening, and an external nozzle mounted on the carrier plate and surrounding an exterior of the internal nozzle, the external nozzle configured to receive the core polymer solution ejected from the internal nozzle and the shell polymer solution and to form an immiscible laminar flow including the core polymer solution surrounded by the shell polymer solution, where the vibration created by the vibration unit can break the immiscible laminar flow as being ejected from the external nozzle through a second opening, forming core-shell droplets, a controller to control the vibration unit and flow rates of the core polymer solution and the shell polymer solution, and a bath to receive the core-shell droplets, the bath being positioned below the vibrational nozzle unit.

In an aspect, combinable with any other aspect, the internal nozzle and the external nozzle are concentrically positioned.

In an aspect, combinable with any other aspect, the system further includes a magnet holder attached to the vibration unit; and a pulsation body between the magnet holder and the carrier plate.

An implementation described herein provides a method of treating produced water, where the method includes: passing produced water through a filter including a core-shell ion-exchange resin to desalinate the produced water via ion-exchange with the core-shell ion-exchange resin, where the core-shell ion-exchange resin is formed by a process including: dissolving a first polymer waste in a first solvent to form a core polymer solution; dissolving a second polymer waste in a second solvent to form a shell polymer solution; feeding the core polymer solution into an internal nozzle contained in an external nozzle; feeding the shell polymer solution into the external nozzle, to a gap between the exterior of the internal nozzle and the interior of the external nozzle; ejecting the core polymer solution from the internal nozzle, forming a laminar flow including the core polymer solution and the shell polymer solution, the shell polymer solution being immiscible with the core polymer solution; vibrating the external nozzle at a frequency; while vibrating the external nozzle, ejecting the laminar flow from the external nozzle, the vibrating breaking the laminar flow and forming a droplet having a core including the core polymer solution and a shell including the shell polymer solution; and forming the core-shell ion-exchange resin from the droplet.

In an aspect, combinable with any other aspect, the core-shell ion-exchange resin is made from a polymer waste.

In an aspect, combinable with any other aspect, the core-shell ion-exchange resin is a cation-exchange resin, and wherein the filter further includes an anion-exchange resin.

In an aspect, combinable with any other aspect, the core-shell ion-exchange resin is an anion-exchange resin, and wherein the filter further includes a cation-exchange resin.

In an aspect, combinable with any other aspect, passing the produced water through the filter includes: performing a first ion exchange with a cation-exchange resin; and performing a second ion exchange with an anion-exchange resin.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of making a core-shell ion-exchange resin, the method comprising:
dissolving a first polymer waste in a first solvent to form a core polymer solution;
dissolving a second polymer waste in a second solvent to form a shell polymer solution, the second polymer waste being different from the first polymer waste;
feeding the core polymer solution into an internal nozzle contained in an external nozzle;
feeding the shell polymer solution into the external nozzle, to a gap between the exterior of the internal nozzle and the interior of the external nozzle;
ejecting the core polymer solution from the internal nozzle, forming a laminar flow comprising the core polymer solution and the shell polymer solution, the shell polymer solution being immiscible with the core polymer solution;
vibrating the external nozzle at a frequency;
while vibrating the external nozzle, ejecting the laminar flow from the external nozzle, the vibrating breaking the laminar flow and forming a droplet having a core comprising the core polymer solution and a shell comprising the shell polymer solution; and
forming a core-shell ion-exchange resin from the droplet, the core-shell ion-exchange resin having a shell comprising functional groups capable of ion exchange in a solution.

2. The method of claim 1, further comprising:
prior to dissolving the first polymer waste, washing a polymer waste mixture comprising the first polymer waste;
isolating the first polymer waste from the polymer waste mixture; and
grinding the first polymer waste into granules.

3. The method of claim 1, further comprising:
prior to dissolving the second polymer waste, washing a polymer waste mixture comprising the second polymer waste;
isolating the second polymer waste from the polymer waste mixture; and
grinding the second polymer waste into granules.

4. The method of claim 1, further comprising prior to feeding the core polymer solution into an internal nozzle, adding a carbonate and an acid to the core polymer solution, wherein a gas is formed by a reaction of the carbonate and the acid while forming the core-shell ion-exchange resin, and wherein the gas forms pores in a core of the core-shell ion-exchange resin.

5. The method of claim 1, further comprising prior to feeding the shell polymer solution into an external nozzle, adding a carbonate and an acid to the shell polymer solution, wherein a gas is formed by a reaction of the carbonate and the acid while forming the core-shell ion-exchange resin, and wherein the gas forms pores in the shell of the core-shell ion-exchange resin.

6. The method of claim 1, wherein the first polymer waste comprises a polystyrene based copolymer, a poly(styrene-isoprene) based copolymer, an aromatic substituted vinyl copolymer, a polyurethane based copolymer, an acrylonitrile butadiene styrene-based copolymer, a polyimide, or a polyimide based copolymer.

7. The method of claim 1, wherein the second polymer waste comprises an acrylic polymer, a polyolefin, a polyester, or an amine-containing polymer.

8. The method of claim 1, wherein the internal nozzle has an opening with a diameter between 0.1 mm and 1 mm, and wherein the external nozzle has an opening with a diameter between 0.5 mm and 10 mm.

9. The method of claim 1, wherein the frequency is between 40 Hz and 6 kHz.

10. The method of claim 1, further comprising providing the droplet into a polymer precipitating bath, precipitating a solid core-shell resin.

11. The method of claim 10, wherein the solid core-shell resin has a shell comprising functional groups capable of ion exchange in a solution.

12. The method of claim 10, wherein the solid core-shell resin has a shell without the functional groups, and wherein forming the core-shell ion-exchange resin comprises performing a plasma treatment on the solid core-shell resin to form the functional groups on the shell of the solid core-shell resin.

13. The method of claim 10, wherein the solid core-shell resin has a shell without the functional groups, and wherein forming the core-shell ion-exchange resin comprises performing a chemical treatment on the solid core-shell resin to form the functional groups on the shell of the solid core-shell resin.

14. The method of claim 1, wherein the solid core-shell ion exchange resin is a cation-exchange resin, and wherein the functional groups comprise sulfonic acid, carboxylic acid, or chelating ligands.

15. The method of claim 1, wherein the solid core-shell ion-exchange resin is an anion-exchange resin, and wherein the functional groups comprise amines.

16. A method of making an ion-exchange filtration system, the method comprising:
ejecting a first laminar flow comprising a first core polymer solution and a first shell polymer solution from a first vibrating nozzle, the first vibrating nozzle breaking the first laminar flow to form a first core-shell droplet;
forming a first core-shell ion-exchange resin from the first core-shell droplet;
ejecting a second laminar flow comprising a second core polymer solution and a second shell polymer solution from a second vibrating nozzle, the second vibrating nozzle breaking the second laminar flow to form a second core-shell droplet;
forming a second core-shell ion-exchange resin from the second core-shell droplet;
loading the first core-shell ion-exchange resin into a first portion of a filter column; and
loading the second core-shell ion-exchange resin into a second portion of the filter column.

17. The method of claim 16, wherein the first core-shell ion-exchange resin has a shell comprising a cation-exchange resin and the second core-shell ion-exchange resin has a shell comprising an anion-exchange resin.

18. The method of claim 16, wherein the first core-shell ion-exchange resin or the second core-shell ion-exchange resin has a shell comprising a chelate resin.

19. The method of claim 16, further comprising, performing a plasma treatment or a chemical treatment on the first or second core-shell ion-exchange resin to introduce functional groups capable of ion exchange in a solution.

20. The method of claim 19, wherein the functional groups comprise sulfonic acid, carboxylic acid, chelating ligands, or amines.

21. A system for forming a core-shell ion-exchange resin, the system comprising:
a first container comprising a core polymer solution, the core polymer solution being prepared by dissolving a first polymer waste in a first solvent;
a second container comprising a shell polymer solution, the shell polymer solution being prepared by dissolving a second polymer waste in a second solvent;
a vibrational nozzle unit comprising,
a vibration unit configured to vibrate at a frequency,
a carrier plate,
an internal nozzle mounted on the carrier plate, the internal nozzle configured to receive the core polymer solution and to eject the core polymer solution through a first opening, and
an external nozzle mounted on the carrier plate and surrounding an exterior of the internal nozzle, the external nozzle configured to receive the core polymer solution ejected from the internal nozzle and the shell polymer solution and to form an immiscible laminar flow comprising the core polymer solution surrounded by the shell polymer solution,
wherein the vibration created by the vibration unit can break the immiscible laminar flow as being ejected from the external nozzle through a second opening, forming core-shell droplets,
a controller to control the vibration unit and flow rates of the core polymer solution and the shell polymer solution, and
a bath to receive the core-shell droplets, the bath being positioned below the vibrational nozzle unit.

22. The system of claim 21, wherein the internal nozzle and the external nozzle are concentrically positioned.

23. The system of claim 21, further comprising:
a magnet holder attached to the vibration unit; and
a pulsation body between the magnet holder and the carrier plate.

24. A method of treating produced water, the method comprising
passing produced water through a filter comprising a core-shell ion-exchange resin to desalinate the produced water via ion-exchange with the core-shell ion-exchange resin, wherein the core-shell ion-exchange resin is formed by a process comprising:
dissolving a first polymer waste in a first solvent to form a core polymer solution;
dissolving a second polymer waste in a second solvent to form a shell polymer solution;
feeding the core polymer solution into an internal nozzle contained in an external nozzle;
feeding the shell polymer solution into the external nozzle, to a gap between the exterior of the internal nozzle and the interior of the external nozzle;
ejecting the core polymer solution from the internal nozzle, forming a laminar flow comprising the core polymer solution and the shell polymer solution, the shell polymer solution being immiscible with the core polymer solution;
vibrating the external nozzle at a frequency;
while vibrating the external nozzle, ejecting the laminar flow from the external nozzle, the vibrating breaking the laminar flow and forming a droplet having a core comprising the core polymer solution and a shell comprising the shell polymer solution; and
forming the core-shell ion-exchange resin from the droplet.

25. The method of claim 24, wherein the core-shell ion-exchange resin is made from a polymer waste.

26. The method of claim 24, wherein the core-shell ion-exchange resin is a cation-exchange resin, and wherein the filter further comprises an anion-exchange resin.

27. The method of claim 24, wherein the core-shell ion-exchange resin is an anion-exchange resin, and wherein the filter further comprises a cation-exchange resin.

28. The method of claim 24, wherein passing the produced water through the filter comprises:
performing a first ion exchange with a cation-exchange resin; and
performing a second ion exchange with an anion-exchange resin.
